(19) United States
(12) Patent Application Publication
(10) Pub. No.: US 2013/0317910 A1
(43) Pub. Date: Nov. 28, 2013

(54) Systems and Methods for Contextual Recommendations and Predicting User Intent

(71) Applicant: Moataz A. R. Mohamed, San Ramon, CA (US)

(72) Inventor: Moataz A. R. Mohamed, San Ramon, CA (US)

(73) Assignee: VUFIND, INC., Sunnyvale, CA (US)

(21) Appl. No.: 13/478,832

(22) Filed: May 23, 2012

(51) Int. Cl. G06Q 30/02

(52) U.S. Cl. 705/14.58; 705/14.66; 705/14.61

(57) ABSTRACT

Aspects of embodiments of the present invention pertain to a system and method for supplying targeted contextual recommendations, advertisements or commercial offers to mobile users based on their interest graph and spacio-temporal map of each user's mobile activities and behavioral patterns. A novel powerful likely intent score is computed based on leveraging both the interest graph and computing persona similarities based on psychographic analysis and spacio-temporal activity maps.

### FIELD OF THE INVENTION

Embodiments of the present invention relate generally to systems and methods for personalization of information, recommendations, and commercial offers such as advertisements, coupons and deals displayed to mobile users, and forecasting if such information matches user intent and will more likely result in clicks and transactions. More specifically, embodiments of the present invention are based on psychographic and behavioral analysis, and comparing interest profiles of users of similar personas according to an interest graph of a community of users compiled via mobile applications or services.

### BACKGROUND

Targeting of advertisements, rewards and deals, henceforth referred to as “Commercial Offers”, is commonly done using age, gender, location, and income level, collectively referred to as demographic targeting and infrequently using social graphing. However, these approaches have failed to achieve any significant advertising engagement on mobile devices or smartphone applications. The click through rates are lowest amongst all advertising channels due to the fact that mobile devices are designed to be personal, and thus users expect information dispensed to be personalized to their individual tastes and interests.

Recommendation engines typically provide recommendations based on one or more of the following criteria:
a. past purchase history
b. past browsing history
c. product correlation (e.g. those who bought this also bought that)
d. demographic targeting (e.g. 35 year old female living in upscale neighborhood may be interested in a BMW)
   Such criteria, while important factors, are not as contextually accurate and temporally current as a dynamic interest profile inferred from the interest graph. Therefore there is a need for recommendations based on the interest graph and persona similarities that leverage psychographic behavioral analysis to ensure highest relevance and maximize user interest, resulting in clicks, redemptions, and commercial transactions.

### SUMMARY

A method for determining personalized recommendations and commercial offers based on interest graphs of users of web-based applications via a computing device comprising compiling data concerning the respective community of users of said application, establishing interest profiles and interest graph for said users from said compiled data, filtering noise and calibrating said compiled data, structuring said compiled data as a spacio-temporal activity map for each user, structuring a dynamic weighted interest profile for said user based on said spacio-temporal activity map, and displaying recommendations, commercial offers to said users that are contextual with respect to time and space, wherein said additional information is based on similarity score of said user's dynamic interest profile against other users with similar interests.

A method for supplying personalized recommendations and commercial offers based on interest graph of users of web-based mobile applications comprising compiling data concerning the respective community of users of said application, establishing interest profiles and interest graph for said users based on said compiled data, filtering noise and calibrating said compiled data, structuring said compiled data as a spacio-temporal activity map for each user, structuring a dynamic weighted interest profile for said user based on said spacio-temporal activity map, and displaying recommendations and commercial offers to said users that are contextual with respect to time and space, wherein said additional information is based on activity of a user with high similarity score who is in a close proximity to said user at the current time.

A system for computing likely intent and performing persona similarity measurements based on interest graph of users of mobile web-based applications comprising at least one server hosting at least one software module programmed to infer user interests based on a multiplicity of mobile user activity data, at least one other software module programmed to populate spacio-temporal activity maps of said users and associated interests, venues and brands, at least one database module adapted for storing said users' detailed spacio-temporal activity maps, weighted interest profiles, and keyword-interest mapping between keywords and interests, at least one web API for receiving said users' activities from at least one application server, and at least one mobile application client running on a mobile computing device configured to enable a connection with at least one mobile application server wherein said at least one mobile application server for said at least one mobile application hosts user data and user activities on said mobile application and posts said user data and user activities to at least one interest graph server via said web-based APIs.

Other objects, advantages, and applications of the embodiments of the present invention will be made clear by the following detailed description of a preferred embodiment of the present invention. The description makes reference to drawings in which:

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1 illustrates an interest graph in accordance with an embodiment of the present invention

FIG. 2 illustrates a spacio-temporal behavioral activity and interest map in accordance with an embodiment of the present invention;

FIG. 3 illustrates an embodiment of a flowchart for computing Persona Similarity Score

FIG. 4 illustrates an embodiment of a flowchart for computing Likely Intent

FIG. 5 illustrates an embodiment of a system block diagram for the system for computing persona similarity and likely intent

FIG. 6 illustrates an embodiment of an exemplary table for keyword-interest mapping

FIG. 7 illustrates and embodiment of an exemplary table for Spacio-Temporal Activity Maps

### DETAILED DESCRIPTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein. Rather, the disclosed embodiments are provided so that this disclosure will be thorough and complete, and will fully convey the scope of the invention to those skilled in the art.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

Thus, as described below, various embodiments of the invention may be readily combined, without departing from the scope or spirit of the invention. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In one embodiment of the present invention, a compelling contextual recommendation/ad/deal/reward targeting platform is based on the creation of an interest graph of a set of mobile users. In one exemplary embodiment, an interest graph is composed of interest indicators, such as, likes, dislikes, and check-ins. One example of an interest graph is discussed in U.S. patent application Ser. No. 13/462,787 entitled Systems and Method for Intelligent Interest Data Gathering From Mobile-Web Based Applications, filed May 2, 2012 by the same inventor as the instant application. As described herein, many strong interest indicators are applicable to mobile users however do not exist on the web, for example check-ins, camera, and NFC (i.e., using Near Field Communications for purchases). One embodiment of the novel effective mobile interest graph targeting platform herein makes effective use of some or all these signals to provide real-time personalized analysis of the user's apparent interests via his or her activities on various social-web applications and platforms. These mobile activities and associated interest indicators enable the performance of advanced and more accurate psychographic and behavioral analysis of a user's persona, which enable precise targeting of information and commercial offers to a user's tastes and preferences. Psychographic and behavioral targeting on the web has traditionally meant relying on search and browsing history to infer the user's interests based on what they are reading or what website or portal the user has visited. However, on the mobile web, a checkin directly correlates to purchasing behavior, since users rarely checkin at restaurants or shops that they don't like or haven't purchased goods at. Similarly photos are typically indicative of positive experiences and hence are strong indicators of personality and behavior.

In one embodiment an exemplary system for computing persona similarity measure based on an interest graph of a set of mobile users, and using such similarity measures to compute probable intent and/or likelihood of a click, purchase, reward redemption or commercial transaction on a personalized contextual recommendation or commercial offer is described. Such systems may be implemented through web-based augmented-reality applications. As used in conjunction with the present embodiment, contextual means targeted to the user's Mobile Context, which is defined as time, location, and potential intent/frame of mind. However it is contemplated within the scope of the present embodiments that the term contextual may be much broader including but not limited to involving, or depending on any context.

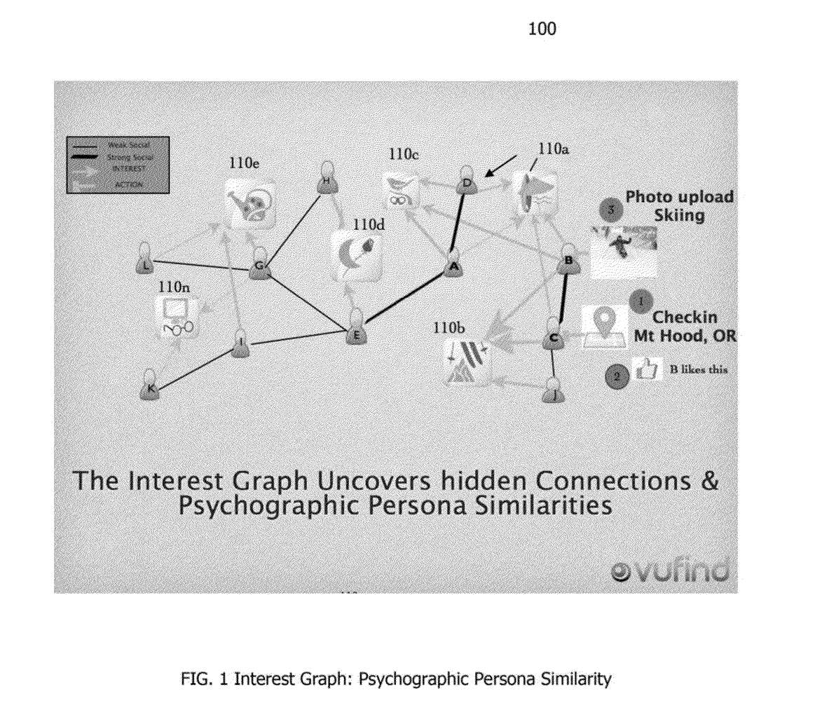

FIG. 1 depicts an exemplary interest graph 100. In the interest graph 100, interests are shown with graphical icons 110(a . . . n). The interests depicted by the graphical icons 110(a . . . n) represent interests inferred from user activities such as a photo uploaded by a user 3, a check-in 1, a “like” button 2, or any other method or means by which a user identifies an interest. Users (A . . . K) are identified and each user is graphically connected, depicted by an arrow, to his or her interest (the graphical icons 110(a . . . n)). While indicated as Users (A . . . K) there is no limitation is intended by such and there may be any number and an unlimited number of users as represented by (A . . . K), similarly while FIG. 1 depicts a . . . f interest icons, this is not so limited and any number including an unlimited number of interest icons (a . . . n) are contemplated within the scope of the embodiments of the present invention. Users may also indicate activity interests 1, 2, 3 depicted by t-connectors. T-connectors indicate an action, for example, a user action that just happened such as, but not limited to, a photo upload, a checkin, or clicking a like button, or posting a comment. While specific types of interests are described in conjunction with the interest graph 100, this is not intended to be a limitation on the type or kind of interests that may be identified and any other interests including but not limited to interests in people, reports, books, movies, food, clothing are contemplated within the scope of the embodiments of the present invention. Users are then connected to other users through these interests. For example, users with similar personas all over the world have digital connections through social networks, even though these individuals never met and most likely would have never met until the social networking phenomena. As a further example, open public networks permit a user to ‘follow or subscribe to’ anyone. Because of their similar persona and interests, posts, photos, checkins, links, and the like users create a direct connection. As a further example, a user may choose not to follow or did not know about another individual, they may still have an interest graph connection between them, namely that their persona profiles may look very similar. A strong social connection may exist, indicated by a heavy line in the interest graph 100, or a weak social connection may exist, indicated by a lighter line. For example, interests may be determined by the weight in the profile based on frequency of the activity (for example, checked in at a certain sushi bar 4 times last week may indicate a strong interest) and recentness (user “liked” a certain product's “fanpage” a while ago, for example, three years ago, may indicate a weak interest.) As a further example, social interests may be determined by a close friend (which may be indicative of numerous interactions, activities, messaging, emails, etc.). A weak social link may indicative of infrequent interactions, such as, for example, a simple “like” click on a fellow user's birthday post once a year. The graphical representation enables one to quickly view connections and persona similarities that may not be readily apparent or obvious.

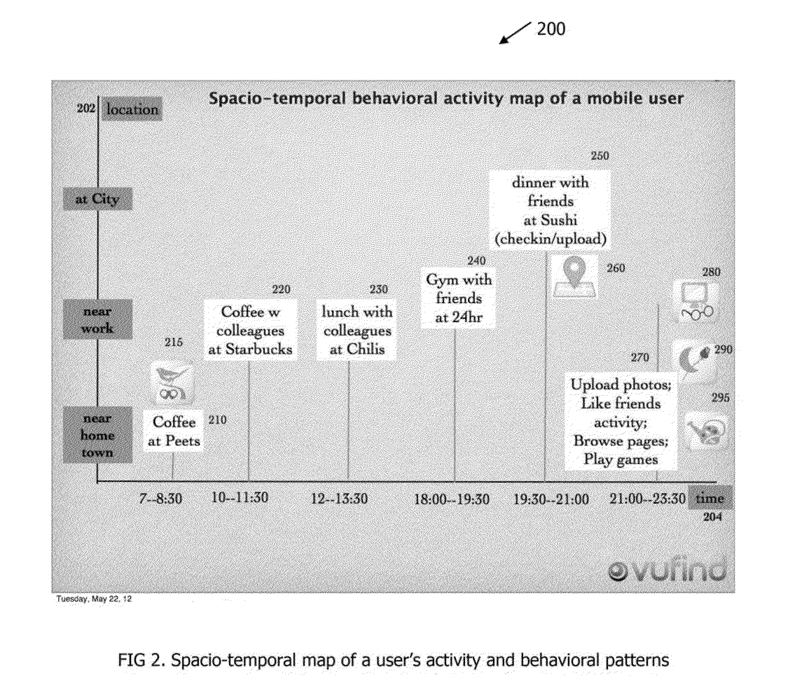

FIG. 2 depicts an exemplary spacio-temporal behavioral activity and interest map 200. Generally, the spacio-temporal map 200 depicts a user's activity and behavioral patterns. In one embodiment the spacio-temporal map relates location of a user, y axis 202, to the time of day, x-axis 204. The spacio-temporal map indicates the activities 210, 215, 220, 230, 240, 250, 270 of a user and the interests, 280, 290, 295 and likes 260 of a user as a function of the time such interest or activity is performed or indicated. The location may be set as a specific place or a distance from a known place or by any other means that may indicate a location. The time may be set in increments of any length, including but not limited to, minutes, hours, days.

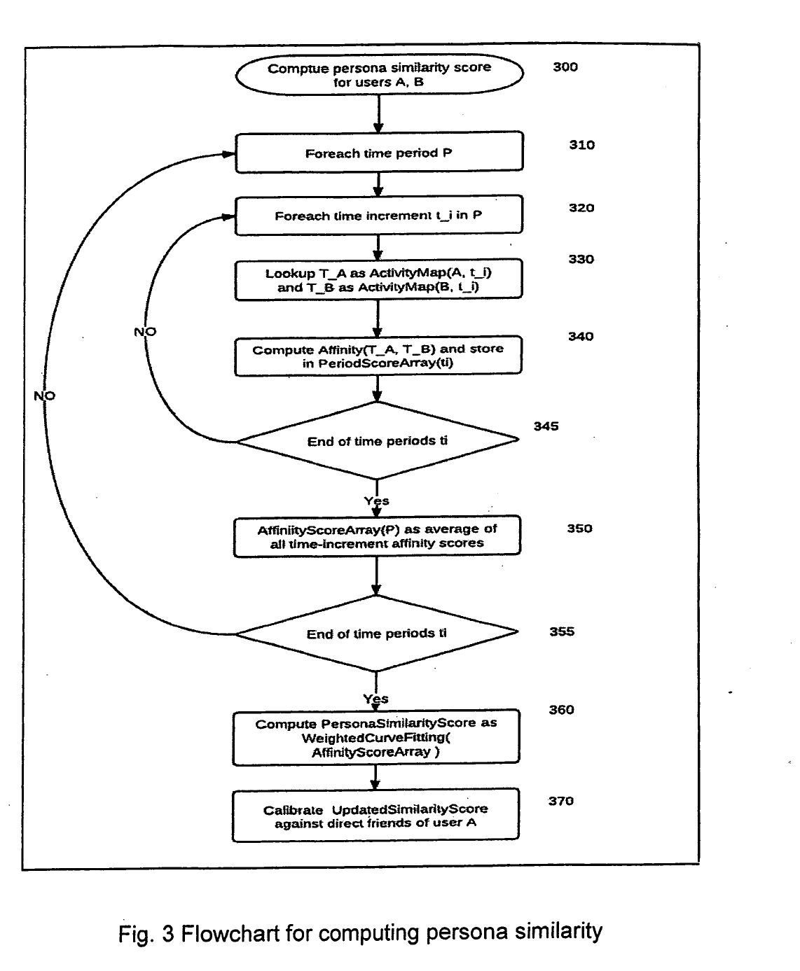

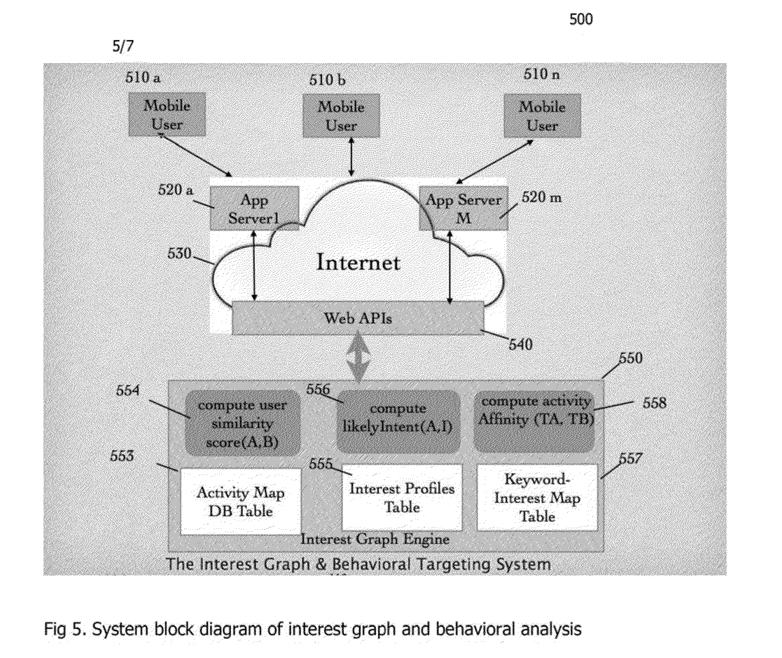

FIG. 3 illustrates an embodiment of a flowchart 301 for computing a Similarity Score. The present exemplary embodiment depicts a method for computing the similarity score for two users, A and B, 305 however the method presented herein is not so limited and is equally applicable for computing the similarity score for any number of users. A user's day may be broken up into periods P of activities 310. The activity periods P may be designated in any variety of ways, temporally or by general time blocks such as but not limited to early morning, mid-morning, lunch time. If the latter is chosen, then each period P 310 is further broken down as needed into time increments t_i (“t_i” and “ti” are used interchangeably herein) 320, such as hours, minutes, and/or seconds. A user “A's” activity T_A is looked up at a particular time ti 330 and a user B's activity T_B 330 is also obtained. The closeness of T_A and T_B via the function computeAffinity is calculated 340. For example if both activities T_A and T_B involved buying coffee at a coffee shop but one user went to Starbucks and the other went to another coffee shop then the AffinityScore at that time is high but not a perfect 100% which would be the case if they went to the same coffee shop chain. As a further example, the closeness of an activity TA of user A at ti to the activity TB of user B at ti is determined by, for example, if A goes sailing, while B goes sky-diving, these activities have nothing in common other than both being outdoors, hence should have very low AffinityScore but not 0 due to the outdoors element. If A goes sailing, while B goes kayaking—both of these are under the genre of water-sports and hence have high AffinityScore or closeness measure. ComputeAffinity may look at the context and classification of the interest according to object and interest ontology which is explained further in the keyword-interest map table in FIG. 5. As a further example, unless the interest is inferred from a “checkin” at a sailing club, most likely it'll come from a photo upload that has a sailboat, or text comment, or any other similar digital imprint. In our interest ontology, we look up what interests to infer from the sailboat object. For example, sailboat keyword maps to the interests: sailing, water-sports, marine, ocean, outdoors, while the kayak keyword maps to the interests: sailing, water-sports, marine, rivers, lakes, outdoors. Therefore, ComputeAffinity (sailing, kayaking) will give a high AffinityScore because the number of common interest categories between these two activities sailing and kayaking is very high. This process may be completed until all the scores for a desired time period are calculated 345.

The affinityScore for the entire time period P may then be computed by averaging the scores for each time increment within P 350. This process is repeated for all time periods P in the day 355. Time periods may be long or short, may be fixed in blocks or continuous, for example, seconds, minutes, hours, days, weeks, months, years, certain holidays, weekends, weekdays, or any blocks of time. This data is then fitted 360. While depicted as using weighted curve fitting, embodiments of the present invention are not limited to such methods and may include other methods included but not limited to robust regression, weighted linear regression, and weighted least squares. Then the similarity score is calibrated and analyzed against direct friends of the user A 370. Calibration may involve, but is not limited to, comparing the similarity score obtained thus far between users A and B to similarity scores between A and her direct “friends” or direct social connections, or may involve comparing the similarity score between A and the direct friends of user B, or could involve the union of their sets of friends. In the preferred embodiment calibration involves applying a modifier to the current similarity score prior to the calibration to obtain the final similarity score. Such modifier can involve any mathematical or algorithmic process. The calibration method further encompasses logic to take into account the click behavior on commercial offers, reward redemptions, and executed commercial transactions after the similarity has been established, For example if users A and B have earned a similarity score of 90%, however their click patterns on commercial offers differ significantly over time, then the calibration engine will record this fact and will “learn” from it that even though their persona profiles are highly similar, these two users react differently to commercial offers and hence will lower their similarityScore in future invocations of the calibrate method.

In addition in some embodiments, similarity scores may be used for targeting advertising and recommendations to users who share similar activities or interests even if said users are not proximal to each other, or if said interests or activities occur at different times of day. Further in one embodiment targeting advertising and recommendations are made to users who share similar activities or interests even if said users are not proximal to each other, or if said interests or activities occur at similar times of day. In another embodiment only the activity may be similar. As described in conjunction with these particular embodiments, but not necessarily all embodiments, herein similar refers to circumstance, times, activities or location that are related in appearance or nature; or showing resemblance in qualities, characteristics, or appearance; such that they are alike though not identical or the same.

Depicted below is one embodiment of a novel algorithm that performs an embodiment of the method described in FIG. 3.

Algorithm 1: Persona Similarity Score

| | |
|---|---|
| 1. | Inputs: User A, User B, Interest Graph DataBase |
| 2. | For each time period P |
| 3. | for each time increment ti within P |
| a. | T_A= activityMap(user-A, ti); |
| b. | T_B activityMap(user-B, ti); |
| c. | compute PeriodScoreArray(ti) = computeAffinity( T_A, T_B); |
| 4. | end foreach ti |
| 5. | AffinityScoreArray(p) = average(PeriodScoreArray); |
| 6. | end foreach P |
| 7. | compute personaSimilarityScore(AffinityScoreArray ); |
| 8. | foreach direct friend F of user-A |
| 9. | // Calibrate similarity score computed against similar friends of |
| | user-A updatedSimilarityScore =calibrate(personaSimilarityScore, |
| | user-A, F) |
| 10. | return updatedSimilarityScore |

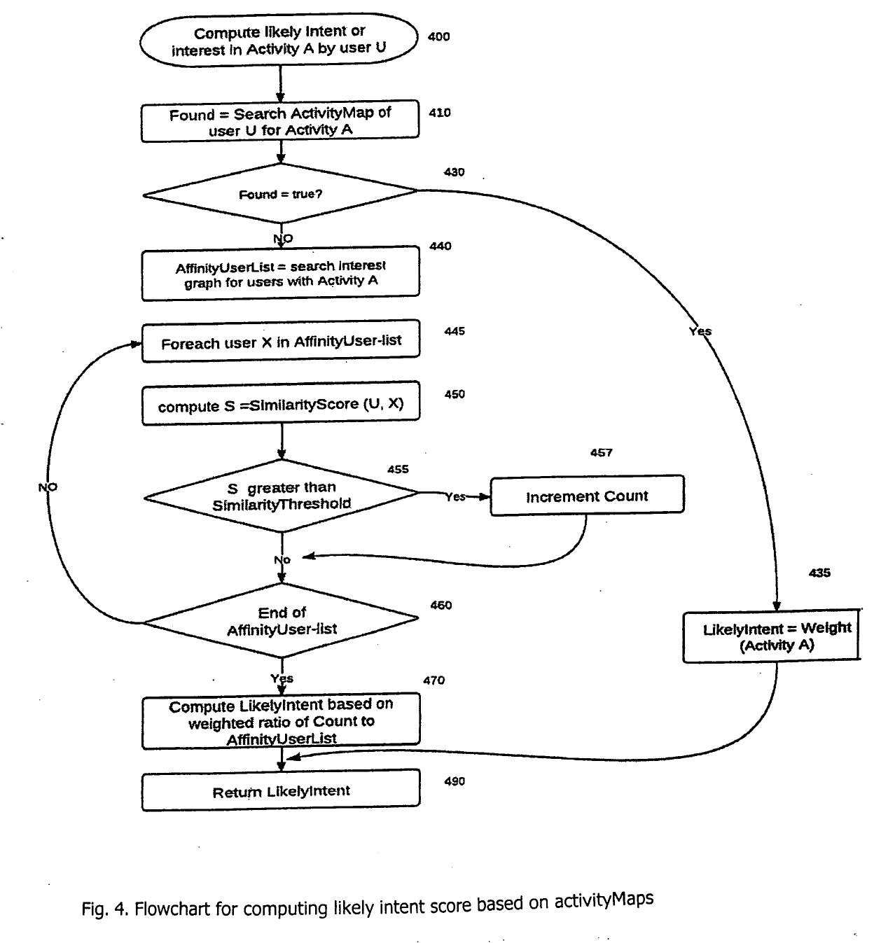

FIG. 4 illustrates an exemplary embodiment of a flowchart for computing Likely Intent. The present embodiment depicts a method for computing the likely intent score of a user based on activity maps. The likely intent score for a user U in an activity A is computed by searching the user's U activity map, and also that user's interest graph to infer a probabilistic measure based on the activities of other users in user's U interest graph 410. As a further example, likely intent may be the probability score of whether user U would be interested in an activity, brand or offer associated with such interest (i.e likely intent or probability for the user to be interested in.). Likely intent and likely interest are used interchangeably here in. The user U activity map is searched for activity A 420. If activity A is found directly in the activity map, 430, then the weight of that activity is looked up 480 and returned as the final likely intent score 490. For example, an activity may be looked up by reading from a database table. As a further example, the weight of the activity may be the same as the weight of the narrow interest representing the activity in interest profile. In other words, if the activity is drink coffee at Starbucks, then the weight of that activity is identical to the weight of the interest “Starbucks coffee”, however, it is different from the broader interests “Coffee” and “Cafes”. If the activity A is not found as a direct activity of user A, then the user's interest graph is searched to produce a list of users user_list that have activity A in their activity maps 440. We loop through this user_list for each user X 445 and the AffinityScore is computed between user X and user U 450. The AffinityScore S is compared against a threshold “closeness” measure SimilarityThreshold 455, and if it's higher than that threshold, a count is incremented 457.

The total count of all users in the interest graph who have passed the AffinityScore threshold is determined 470. The percentage of these users to the AffinityUserList is computed 480. This percentage is returned as the likely intent score 490.

Depicted below is one embodiment of a novel algorithm that performs an embodiment of the method described in FIG. 4 using interest graphs and spacio-temporal activity maps:

Algorithm 2: Likely Intent Score

| | |
|---|---|
| 1. | Inputs: an activity, interest topic, or brand A and input user U |
| 2. | Output: compute the score for likely intent or interest of user U in |
| | activity A |
| 3. | Interest I = Look up the interest category of Activity A in the Activity- |

Interest Table

| | |
|---|---|
| 4. | Found = Search user U's Profile for Interest I |
| 5. | if not Found then { |
| 6. | User-list = search interest graph for users with interest I |
| 7. | foreach user X in User-list |
| 8. | S = compute SimilarityScore (U, X) |
| 9. | if S > similarity-threshold { |
| 10 | count++; |
| | } |
| 11 | LikelyIntent = compute likely intent based on the % count/#User-list; |
| | return LikelyIntent; |
| 12 | else { // found the interest I in the user's interest profile |
| | return weight (Interest I ) } |

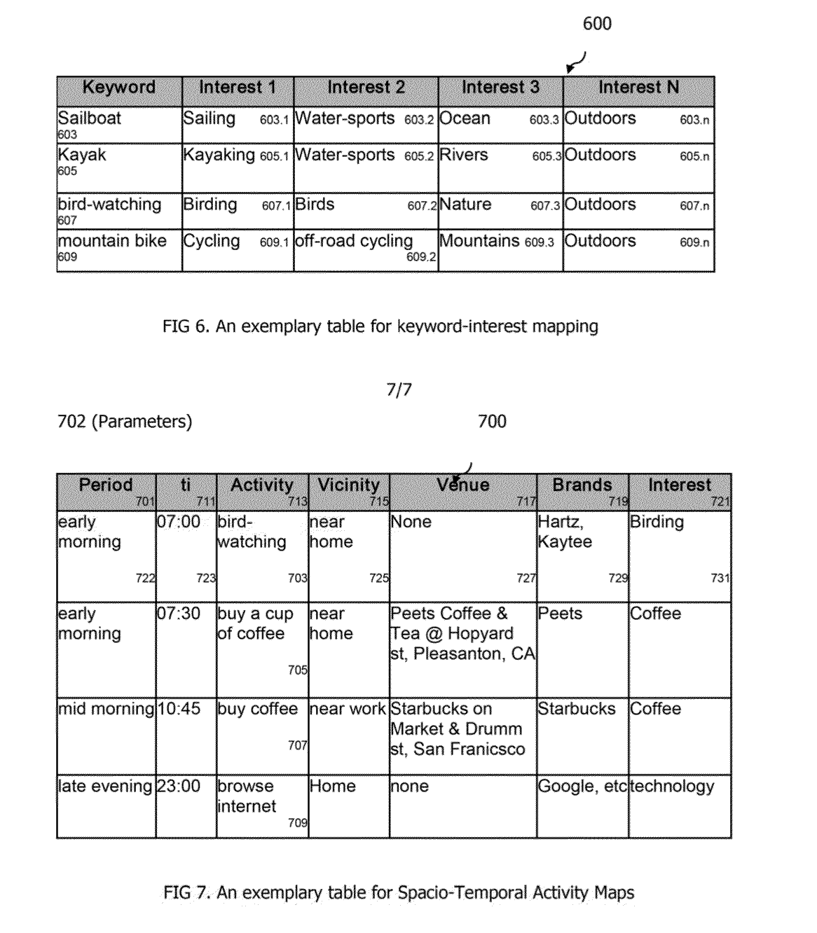

FIG. 5 illustrates an exemplary embodiment of a system for psychographic behavioral analysis of mobile users activities and interests, and leveraging said analysis to compute persona similarity and Likely Intent. The present embodiment depicts a system for computing the likely intent score of a user based on the interest graph leveraging both daily activity maps and the interest graph 500. Mobile users 510a . . . 510n share their activities to the application servers 520a . . . 520m of the applications that they normally use through out their day. Said application servers in turn share these user's activities with the interest graph engine 550 via web APIs 540. Such activities includes, but is in no way limited to, photo and video uploads, checkins, likes/+1 s, text comments, friending/un-friending of other users, following/un-following of other users. Each activity shared may have a time stamp. Said activities are stored in ActivityMap tables 553. An example table of an activity map is shown in FIG. 7. Each activity is analyzed for interests as the activity is received, and the inferred interests associated with the activity are stored in the Keyword-Interest Map 557. An example table of a Keyword-Interest mapping is shown in FIG. 6. Periodically the Interest Graph engine 550 performs interest profile updates to the user's interest profiles and stores it the databases in InterestProfile tables 555.

On top of this data infrastructure, the interest Graph engine employs several methods for computing persona similarity between two users user A, and user B 554, and computing the probabilistic score for likely interest or likely intent of a user A in an interest or activity I 556. Said methods are further explained in full detail in the following figures and flow charts.

FIG. 6 illustrates an exemplary embodiment of a Keyword-Interest map 600. Exemplary activities 603, 605, 607, and 609 are associated with inferred interests to Exemplary activities 603, 605, 607, and 609. Associated interests may be pre-defined and stored in a database. Interests may be read from the database. For example, inferred interests 603.1, 603.2, 603.3, and 603.n are associated with exemplary activity 603. Similarly, inferred interests 605.1, 605.2, 605.3, and 605.n are associated with exemplary activity 605. Inferred interests 607.1, 607.2, 607.3, and 607.n are associated with exemplary activity 607. Also, inferred interests 609.1, 609.2, 609.3, and 609.n are associated with exemplary activity 609. No limitation is intended by the number of exemplary activities, and there may be any number of exemplary activities. Similarly, there is no limitation on the number of inferred interests and there may be any number of inferred interests.

FIG. 7 illustrates an exemplary embodiment of a table for Spacio-Temporal activity map 700. Exemplary activities are illustrated 703, 705, 707, and 709. Any number of parameters 702 may be associated with activities 703, 705, 707, and 709. For example, parameters 702 may include, a time period 701, a time stamp ti 711, a vicinity 715, a venue 717, and a brand 719. For example, with regards to activity 703, period 722 may be associated to activity 703. Period 722 may be obtained from the time period, which may signify any block of time, activity 703 took place. Time stamp ti 723 may be associated to activity 703. Time stamp ti 723 may be obtained from the time activity 703 took place. For example, if a picture is uploaded, the time stamp may be the time the picture was taken or uploaded. Vicinity 725 may be associated with activity 703. Vicinity 725 may be obtained from activity 703 itself. For example, if the picture or other data geographically tags a specific location, vicinity 725 may represent that location. Venue 727 may be associated with activity 703. For example, if the picture, check-in, or other data is associated with a specific venue such as a coffee shop, then venue 727 may represent that specific venue. Brand 729 may be associated with activity 703. For example, if the picture, check-in, or other data provides information on a specific brand or logo, then brand 729 is associated With activity 703. Interest 731 may be associated with activity 703, based on information obtained from any number of parameters 702. No limitation is intended by the number of exemplary parameters and exemplary spacio and temporal activities, and there may be any number of of spacio-temporal activities and parameters. Similarly, there is no limitation on the number of inferred interests and there may be any number a of inferred interests.

Although a specific embodiment of the present invention has been described, it will be understood by those of skill in the art they are not intended to be exhaustive or to limit the invention to the precise forms disclosed and obviously many modifications and variations are possible in view of the above teachings, including equivalents. Accordingly, it is to be understood that the invention is not to be limited by the specific illustrated embodiments, but only by the scope of the appended claims.

I claim:

1. A method for determining personalized recommendations and commercial offers based on interest graphs of users of web-based applications via a computing device comprising:
compiling data concerning the respective community of users of said application;
establishing interest profiles and interest graph for said users from said compiled data;
filtering noise and calibrating said compiled data;
structuring said compiled data as a spacio-temporal activity map for each user;
structuring a dynamic weighted interest profile for said user based on said spacio-temporal activity map; and
displaying recommendations, commercial offers to said users that are contextual with respect to time and space, wherein said additional information is based on similarity score of said user's dynamic interest profile against other users with similar interests.

2. The method of claim 1 wherein said spacio-temporal activity map is based on a pre-determined number of periods of times.

3. The method of claim 1 wherein said spacio-temporal activity map is based on a pre-determined number of locations that each user visits during the day.

4. The method of claim 1 wherein said spacio-temporal activity map specifies activity type, interest and venue.

5. The method of claim 1 wherein said spacio-temporal activity map specifies activity venue and at least one brand associated with said activity type and venue.

6. The method of claim 1 wherein the recommendations are contextual to time.

7. The method of claim 1, wherein the recommendation are contextual to location.

8. The method of claim 1, wherein the recommendation are based on the likely interest score.

9. The method of claim 1 as enacted by a computing device means for supplying personalized recommendations and commercial offers to users of web-based augmented-reality applications wherein the augmented reality application displays such recommendations and offers only when they match the user's mobile context defined by at least one of likely interest, time, or location.

10. A method for supplying personalized recommendations and commercial offers based on interest graph of users of web-based mobile applications comprising:
compiling data concerning the respective community of users of said application;
establishing interest profiles and interest graph for said users based on said compiled data;
filtering noise and calibrating said compiled data;
structuring said compiled data as a spacio-temporal activity map for each user;
structuring a dynamic weighted interest profile for said user based on said spacio-temporal activity map; and
displaying recommendations and commercial offers to said users that are contextual with respect to time and space, wherein said additional information is based on activity of a user with high similarity score who is in a close proximity to said user at the current time.

11. The method of claim 10, wherein supplying contextual recommendations and commercial offers is based on activity of a user with high similarity score who is not in close proximity to said user at a current time but is engaged in a similar activity during a similar time of day in said user's behavioral map.

12. The method of claim 10, wherein supplying contextual recommendations and commercial offers is based on activity of a user who is socially connected to a current user.

13. The method of claim 10, wherein supplying contextual recommendations and commercial offers is based on activity of a user who is socially connected to a current user, and engaged in a similar activity during a predetermined threshold time.

14. The method of claim 10, wherein supplying contextual recommendations and commercial offers is based on activity of a user who is socially connected to a current user, and is in close proximity to current user.

15. A system for computing likely intent and performing persona similarity measurements based on interest graph of users of mobile web-based applications comprising:
at least one server hosting at least one software module programmed to infer user interests based on a multiplicity of mobile user activity data;
at least one other software module programmed to populate spacio-temporal activity maps of said users and associated interests, venues and brands;
at least one database module adapted for storing said users' detailed spacio-temporal activity maps, weighted interest profiles, and keyword-interest mapping between keywords and interests;
at least one web API for receiving said users' activities from at least one application server; and
at least one mobile application client running on a mobile computing device configured to enable a connection with at least one mobile application server wherein said at least one mobile application server for said at least one mobile application hosts user data and user activities on said mobile application and posts said user data and user activities to at least one interest graph server via said web-based APIs.

16. The system of claim 15 wherein said at least one other software module uses said activity maps to compute affinity of said user activity to another activity.

17. The system of claim 15 wherein said at least one other software module uses said activity maps and said interest profiles for psychographic and behavioral analysis to compute persona similarity scores.

18. The system of claim 15 wherein said at least one software module uses said activity maps and said interest profiles for psychographic and behavioral analysis to compute a probabilistic score for likely interest of a specified user in a specific activity.

19. The system of claim 15 wherein said at least one software module uses said activity maps and said interest profiles for psychographic and behavioral analysis to compute a probabilistic score for likely interest of a specific user in a specific commercial offer.

20. The system of claim 15 wherein a software method uses said activity maps and said interest profiles for psychographic and behavioral analysis to compute a probabilistic score for likely interest and/or intent of a given user in a specific software application or game.
